(19) United States
(12) Patent Application Publication
(10) Pub. No.: US 2026/0265438 A1
(43) Pub. Date: Sep. 10, 2026

(54) CONDUCTIVE MATERIAL WITH SELF-HEALING FUNCTIONALITY, A METHOD FOR MANUFACTURING THE SAME, AND A USE THEREOF

(71) Applicants: HYUNDAI MOTOR COMPANY, Seoul (KR); KIA CORPORATION, Seoul (KR); POSTECH RESEARCH AND BUSINESS DEVELOPMENT FOUNDATION, Pohang-si (KR)

(72) Inventors: Yongho Lee, Hwaseong-si (KR); Taerim Lee, Hwaseong-si (KR); Dongjoo Kim, Pohang-si (KR); Sungho Kim, Pohang-si (KR); Soojin Park, Pohang-si (KR); Jieun Kang, Pohang-si (KR)

(73) Assignees: HYUNDAI MOTOR COMPANY, Seoul (KR); KIA CORPORATION, Seoul (KR); POSTECH RESEARCH AND BUSINESS DEVELOPMENT FOUNDATION, Pohang-si (KR)

(21) Appl. No.: 19/239,399

(22) Filed: Jun. 16, 2025

(30) Foreign Application Priority Data
Mar. 6, 2025 (KR) 10-2025-0028787

(51) Int. Cl. C08F 292/00; C08F 2/10; H01M 4/02; H01M 4/133; H01M 4/134; H01M 4/38; H01M 4/583; H01M 4/62; H01M 10/0525

(52) U.S. Cl. CPC C08F 292/00; C08F 2/10; H01M 4/133; H01M 4/134; H01M 4/386; H01M 4/583; H01M 4/623; H01M 4/625; H01M 10/0525; H01M 2004/027

(57) ABSTRACT

The present disclosure relates to a conductive material having a self-healing functionality, a method for manufacturing the same, and uses thereof. The conductive material according to an embodiment of the present disclosure may self-heal a degraded negative electrode material, thereby improving charge/discharge cycle life of a lithium-ion battery, and may interact with a negative electrode active material and a binder to enhance the integrity of an electrode. In addition, the conductive material according to an embodiment of the present disclosure may enable Coulombic interactions with ions in the electrolyte, thereby improving an electrochemical performance of the lithium-ion battery.

### CROSS-REFERENCE TO RELATED APPLICATION

This present application claims the benefit of and priority to Korean Patent Application No. 10-2025-0028787, filed on Mar. 6, 2025, in the Korean Intellectual Property Office, the entire disclosure of which is incorporated herein by reference.

### FIELD

The present disclosure relates to a conductive material having a self-healing functionality, a method for manufacturing the same, and a use thereof.

### BACKGROUND

Lithium-ion batteries have been researched over the past several decades with the goal of increasing energy density while achieving stable performance rather than focusing solely on traditional electrochemical characteristics. Accordingly, researchers have focused on silicon-based negative electrode active materials with high capacity. A dispersibility of electrode material particles, determined during the preparation of an electrode slurry in a process of manufacturing an electrode for a lithium-ion battery, has a significant influence on electrochemical performance of the battery. However, existing conductive materials such as carbon black or carbon nanofiber have a physical structure that is difficult to disperse in a solvent, thereby limiting the ability to achieve uniform battery performance. In particular, a low dispersibility of the conductive material may lead to reduced electrical conductivity, resulting in non-uniform battery performance and deterioration of the battery's cycle performance.

Silicon-based negative electrode materials are promising materials that may improve the energy density of lithium-ion batteries, providing higher capacity compared to existing graphite negative electrodes. However, reactions with lithium cause more than 300% volume expansion. This leads to problems such as pulverization of electrode materials, delamination from a current collector, electrical disconnection, and formation of an unstable solid electrolyte interphase (SEI), resulting in severe degradation of the battery. Accordingly, in order to overcome the drawbacks of the silicon-based negative electrode material, development of an effective conductive material is required.

The matters described in this Background section are only to enhance understanding of the background of the disclosure, and should not be taken as acknowledgement that the matters described in the Background section correspond to prior art already known to those having ordinary skill in the art.

### SUMMARY

The following summary presents a simplified summary of certain features. The summary is not an extensive overview and is not intended to identify key or critical elements.

The present disclosure is directed to providing a conductive material capable of exhibiting improved self-healing functionality and water dispersibility, a method for manufacturing the same, and a use thereof.

In addition, the present disclosure is directed to providing a conductive material applicable to green technologies such as batteries for electric vehicles.

An aspect of the present disclosure may provide a conductive material, including a carbon material and an amphiphilic polymer having both an anionic group and a cationic group, wherein the amphiphilic polymer is grafted onto the carbon material.

The carbon material may include a single-walled carbon nanotube (SWCNT), carbon black, carbon fiber, or any combination thereof.

The single-walled carbon nanotube may be surface-modified with a hydroxyl group or a carboxyl group.

The amphiphilic polymer may include a repeating unit represented by Chemical Formula 1 below:

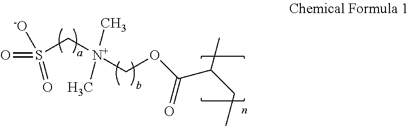

In Chemical Formula 1, a and b may each independently be an integer in a range of 1 to 10, a+b≥4, and n may be an integer in a range of 1 to 20.

The conductive material may include the amphiphilic polymer in an amount of 1 parts by weight to 30 parts by weight based on 100 parts by weight of the carbon material.

Another aspect of the present disclosure may provide a negative electrode including the conductive material and a binder.

The binder may be capable of interacting with the conductive material.

Still another aspect of the present disclosure may provide a lithium-ion battery including the negative electrode.

Yet another aspect of the present disclosure may provide a method for manufacturing a conductive material, the method including preparing a carbon material dispersion by dispersing a carbon material in a solvent, grafting an amphiphilic monomer onto the carbon material by adding the amphiphilic monomer to the carbon material dispersion, and polymerizing the amphiphilic monomer by adding an initiator to form an amphiphilic polymer.

The amphiphilic monomer may include a repeating unit represented by Chemical Formula 2 below:

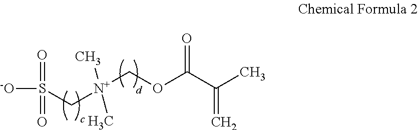

In Chemical Formula 2, c and d may each independently be an integer in a range of 1 to 10, and c+d≥4.

The method may further include surface-modifying the carbon material before preparing the carbon material dispersion.

In the grafting, the amphiphilic monomer may be added in a weight ratio of 1:5 to 1:20 relative to the carbon material included in the carbon material dispersion.

In the polymerizing, the initiator may be added in an amount of 0.05 wt % to 0.2 wt % based on a total weight of the amphiphilic monomer added in the grafting.

The conductive material according to an embodiment of the present disclosure may self-heal a degraded negative electrode material, thereby improving the charge/discharge cycle life characteristics of the lithium-ion battery.

In addition, the conductive material according to an embodiment of the present disclosure may interact with a negative electrode active material and a binder, thereby enhancing the integrity of the electrode.

Further, the conductive material according to an embodiment of the present disclosure may enable Coulombic interactions with ions in the electrolyte, thereby improving the electrochemical performance of a lithium-ion battery.

### BRIEF DESCRIPTION OF THE DRAWINGS

The foregoing and other aspects, features, and advantages, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 shows an image illustrating a conductive material having a self-healing functionality according to an embodiment of the present disclosure.

FIG. 2 shows an image illustrating experimental results for a water dispersibility of conductive materials in an example and a comparative example.

FIG. 3A shows a graph illustrating Fourier Transform Infrared Spectroscopy (FT-IR) analysis results and FIG. 3B shows a graph illustrating thermogravimetric analysis results of conductive materials, in an example and a comparative example.

FIG. 4 shows a graph illustrating FT-IR analysis results confirming interactions between a conductive material and an electrolyte in Example 1.

FIG. 5 shows a graph illustrating adhesion strength evaluation results of electrodes in an example and a comparative example.

FIG. 6 shows the results of evaluating cycle stability of an electrode including the conductive materials of an example and a comparative example.

FIG. 7 shows a graph illustrating expansion evaluation results of electrodes including the conductive material in an example and a comparative example.

FIG. 8 shows graphs illustrating impedance performance evaluation results of batteries including the conductive material in Example 3 and Comparative Example 2.

### DETAILED DESCRIPTION

The present disclosure is described in further detail below with reference to example embodiments. However, the following embodiments are provided merely as references for describing the present disclosure in detail, and the present disclosure is not limited thereto and may be implemented in various forms.

Unless otherwise defined, all technical and scientific terms used herein have the same meaning as commonly understood by those having ordinary skill in the art to which the present disclosure pertains.

The terms used herein are intended merely to describe particular embodiments effectively and are not intended to limit the present disclosure.

Singular forms “a,” “an,” and “the” used in the specification and the appended claims are intended to include plural referents unless the context clearly dictates otherwise.

The units used in this specification, unless otherwise stated, are based on weight. For instance, the units such as “%” or “ratio” refer to weight percent (wt %) or weight ratio, respectively. Unless otherwise defined, weight percent (wt %) refers to the proportion of a specific component within the total composition, expressed as a percentage by weight.

When a portion is described as “including,” “having,” or “comprising” a certain component, it means that, unless specifically stated to the contrary, the inclusion of other components is not excluded but rather that additional components may also be included.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in the specification of the present disclosure, values outside the defined numerical ranges that may occur due to experimental error or rounding off of values are also included within the defined numerical ranges.

For purposes of this application and the claims, using the phrase “at least one of: A; B; or C” or “at least one of A, B, or C,” the phrase means “at least one A, or at least one B, or at least one C, or any combination of at least one A, at least one B, and at least one C.” Further, phrases, such as “A, B, and C”, “A, B, or C”, “at least one of A, B, and C”, “at least one of A, B, or C”, and the like, as used herein may mean each listed item or all possible combinations of the listed items. For example, “at least one of A or B” may refer to (1) at least one A; (2) at least one B; or (3) at least one A and at least one B.

The following provides a more detailed description of the present disclosure.

The present disclosure may provide a conductive material including a carbon material and an amphoteric polymer having both an anion and a cation. The carbon material may be grafted with the amphoteric polymer. The present disclosure also relates to a method for manufacturing the conductive material and a use thereof. The conductive material may include the carbon material grafted with the amphoteric polymer having both the anion and the cation, which enables interaction with a silicon material and a binder, thereby improving adhesion between electrode materials. In addition, even when bonding between electrode materials is broken due to volume changes in the negative electrode during battery charging and discharging, the broken bonding may be self-healed through dynamic secondary interactions based on hydrogen bonding. Further, the amphoteric polymer may interact with water through electrostatic interactions, which may provide the conductive material including the polymer with improved dispersibility in a water-based slurry.

In addition, the present disclosure may provide a conductive material including a carbon material and an amphiphilic polymer having both an anionic group and a cationic group. The amphiphilic polymer may be grafted onto the carbon material.

The carbon material may include a single-walled carbon nanotube (SWCNT), carbon black, carbon fiber, or any combination thereof. Specifically, the carbon material may include a single-walled carbon nanotube. Since the single-walled carbon nanotube is lightweight, exhibits high electrical conductivity and flexibility, and does not cause side reactions with lithium ions, it may be suitable for use as a conductive material in a silicon negative electrode.

The single-walled carbon nanotube may be surface-modified with a hydroxyl group or a carboxyl group. The surface-modified single-walled carbon nanotube may have improved water dispersibility, which may enable efficient performance of the grafting process, and may provide sites for grafting of a monomer or polymer.

The amphiphilic polymer may include a repeating unit represented by Chemical Formula 1 below.

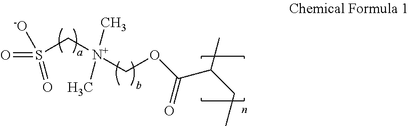

In Chemical Formula 1, a and b may each independently be an integer in a range of 1 to 10, a+b≥4, and n may be an integer of 1 to 20. In an example, a and b may each independently be an integer of 1 to 6, a+b≥4, and n may an integer of 1 to 15, but is not limited thereto as long as the objectives of the present disclosure may be achieved.

When a is 3 and b is 1, the amphoteric polymer may be represented by Chemical Formula 3 below.

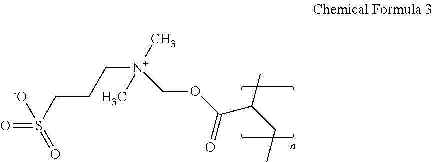

The conductive material may include 1 to 30 parts by weight of a polymer including a hydrogen bondable functional group, based on 100 parts by weight of the carbon material.

Further, the present disclosure may provide a negative electrode including the conductive material and a binder.

The binder may be capable of interacting with the conductive material. When such a condition is met, adhesion between electrode materials may be improved, and strong interactions between the electrode materials may provide self-healing functionalities to the electrode material. The interaction may refer to a phenomenon in which two or more components affect each other, and specifically, may refer to electrostatic interactions such as van der Waals forces and hydrogen bonding.

The binder may include poly(vinylidene fluoride-co-hexafluoropropylene), poly(acrylic acid), carboxymethyl cellulose, poly(vinyl alcohol), Nafion, gelatin, or any combination thereof, but is not limited thereto as long as it is capable of interacting with the conductive material.

The negative electrode may further include a negative electrode active material.

The negative electrode active material may include SiOₓ (0<x<2) (where Si is silicon and O is oxygen), and may further include natural graphite, artificial graphite, Si/C (where C is carbon), or any combination thereof. When such a condition is met, the negative electrode active material may interact with the conductive material and the binder, thereby improving the adhesion and self-healing functionality of the electrode material.

Still further, the present disclosure may provide a lithium-ion battery including the negative electrode.

The lithium-ion battery may further include a positive electrode, an electrolyte, and a separator. The positive electrode, the electrolyte, and the separator are not particularly limited and may be used without limitation as long as they are known in the art.

Moreover, the present disclosure may provide a method for manufacturing a conductive material, the method including preparing a carbon material dispersion by dispersing a carbon material in a solvent, grafting an amphiphilic monomer onto the carbon material by adding the amphiphilic monomer to the carbon material dispersion, and polymerizing the amphiphilic monomer by adding an initiator to form an amphiphilic polymer.

In the following description of the method for manufacturing the conductive material, overlapping descriptions of the conductive material will be omitted.

The amphiphilic monomer may include a repeating unit represented by Chemical Formula 2 below.

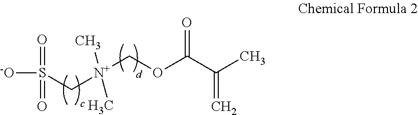

In Chemical Formula 2, c and d may each independently be an integer in a range of 1 to 10, c+d≥4. In an example, c and d may each independently be an integer in a range of 1 to 6, and c+d≥4, but is not limited thereto as long as the objectives of the present disclosure may be achieved.

The method may further include surface-modifying the carbon material before preparing the carbon material dispersion. The carbon material may be surface-modified to form a hydroxyl group or a carboxyl group on the surface of the carbon material. The surface-modified carbon material may be easily dispersed in a water-based solvent, enabling efficient grafting and providing sites for bonding with monomers or polymers.

In the grafting, the amphiphilic monomer may be added in a weight ratio of 1:5 to 20, in an example 1:8 to 15, relative to the carbon material included in the carbon material dispersion, but is not limited thereto as long as the objectives of the present disclosure may be achieved.

In the polymerizing, the initiator may be added in an amount of 0.05 wt % to 0.2 wt %, in an example 0.08 wt % to 0.15 wt %, based on the total amount of the amphiphilic monomer added in the grafting, but is not limited thereto as long as the objectives of the present disclosure may be achieved.

The following describes various Examples and Comparative Examples of the present disclosure. However, the following Examples are merely various Examples of the present disclosure, and the present disclosure is not intended to be limited thereto.

### Example 1

Surface-modified SWCNT was obtained by introducing 0.25 wt % SWCNT into a 10 wt % hydrogen peroxide solution, performing ultrasonic treatment for 5 minutes, and conducting gravity filtration. The resulting material was then vacuum-dried at 50° C.

0.2 g of the surface-modified SWCNTs were ultrasonically dispersed in 100 ml of water for 30 minutes. The SWCNT dispersion was stirred at 60° C. under nitrogen purging.

10 g of a 20 wt % aqueous solution of [2-(methacryloyloxy)ethyl]dimethyl-(3-sulfopropyl) ammonium hydroxide (DMAPS) was added to the above SWCNT dispersion.

Ammonium persulfate (APS) was added as an initiator in an amount of 1 wt % based on the weight of the DMAPS monomer, and grafting was carried out at 60° C. for 24 hours. A conductive material was obtained by grafting poly [2-(methacryloyloxy)ethyl]dimethyl-(3-sulfopropyl) ammonium hydroxide (PDMAPS) onto SWCNTs, followed by gravity filtration and drying.

### Example 2

A conductive material dispersion was prepared by dispersing the conductive material prepared in Example 1 in water. A slurry was prepared by mixing natural graphite, artificial graphite, Si/C, and SiOx as negative electrode active materials, an acrylic copolymer and styrene-butadiene rubber (SBR) as binders, the above conductive material dispersion, and additional SWCNT powder as a conductive material, in a mass ratio of 23.47:54.76:6.70:10.82:1:2:0.25:1. The slurry was cast onto the current collector using a doctor blade. An electrode was prepared by drying at room temperature for one day, followed by pressing and secondary high-temperature vacuum drying at 120° C. for 10 hours.

### Comparative Example 1

A commercial SWCNT that was not grafted with a polymer was used as a conductive material.

### Comparative Example 2

An electrode was prepared in the same manner as in Example 2, except that the conductive material of Comparative Example 1 was used.

### Comparative Example 3

An electrode was prepared in the same manner as in Example 2, except that styrene-butadiene rubber/carboxylmethyl cellulose (SBR/CMC) was used as the binder.

### Experimental Example 1: Evaluation of Water Dispersibility

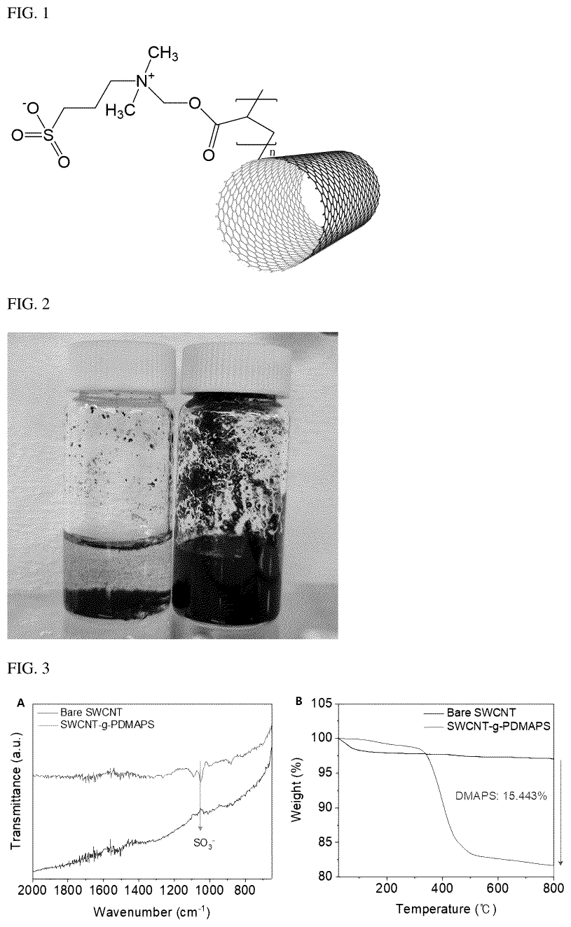

To evaluate the water dispersibility of a conductive material according to the present disclosure, the conductive materials of Example 1 and Comparative Example 1 were dispersed in water, and their appearances after 24 hours were photographed. The results are presented in FIG. 2.

As shown in FIG. 2, the conductive material of Comparative Example 1 settled in water after 24 hours because of its poor water dispersibility. In contrast, the conductive material prepared in Example 1 exhibited improved water dispersibility, remaining uniformly dispersed in water over time.

### Experimental Example 2: Confirmation of Grafting and Polymerization

To confirm whether an amphiphilic polymer was grafted onto the conductive material according to the present disclosure and whether polymerization occurred, Fourier Transform Infrared Spectroscopy (FT-IR) analysis and thermogravimetric analysis (TGA) were performed on the conductive materials of Example 1 and Comparative Example 1. The results are presented in FIG. 3A and FIG. 3B.

As shown in FIG. 3A, the observation of the SO₃⁻ peak in Example 1 confirms that PDMAPS was grafted onto the SWCNTs. In addition, as shown in FIG. 3B, almost no weight change was observed up to 800° C. for the conductive material of Comparative Example 1, whereas the conductive material of Example 1 exhibited a weight loss around 500° C., confirming that 15.443% of polymer was grafted onto the SWCNTs.

### Experimental Example 3: Confirmation of the Interaction Between Conductive Material and Electrolyte

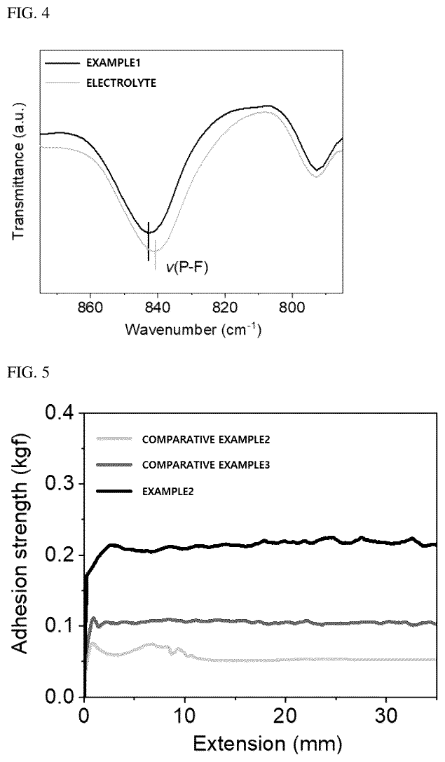

To confirm whether the conductive material according to the present disclosure interacts with the electrolyte, the conductive material of Example 1 was impregnated with a LiPF₆-(where Li is lithium, P is phosphorus, and F is fluorine) based electrolyte and subjected to FT-IR analysis. The results are presented in FIG. 4.

As shown in FIG. 4, a blue shift of the anion peak was observed upon impregnation of the conductive material of Example 1, confirming that the amphiphilic polymer contained in the conductive material promotes the dissociation of ions in the electrolyte, thereby facilitating the formation of free lithium ions. These results suggest that the conductive material according to the present disclosure may improve the electrochemical performance of lithium secondary batteries.

### Experimental Example 4: Evaluation of Electrode Adhesion

To evaluate adhesion of electrodes containing the conductive materials of the Examples and Comparative Examples according to the present disclosure, a 180° peel-off test was conducted. The results are presented in FIG. 5.

As shown in FIG. 5, the electrode of Example 2 exhibited improved adhesion compared to those of Comparative Examples 2 and 3. This is attributed to the fact that the polymer grafted onto the conductive material of Example 2 according to the present disclosure contains abundant oxygen and hydrogen, thereby facilitating hydrogen bonding with hydroxyl groups present on the surface of the negative electrode active material and hydroxyl groups included in the binder. In addition, the electrode adhesion may be further enhanced by electrostatic interactions between the amphiphilic polymers grafted onto the conductive material.

In contrast, Comparative Example 2, which uses commercial SWCNTs, is unable to form effective interactions with the silicon or binder due to the absence of functional groups on the surface of the SWCNTs. Comparative Example 3, which uses a CMC/SBR binder, exhibits reduced electrode adhesion because the binder contains a limited number of sites capable of forming hydrogen bonds.

### Experimental Example 5: Evaluation of Electrode Cycle Stability

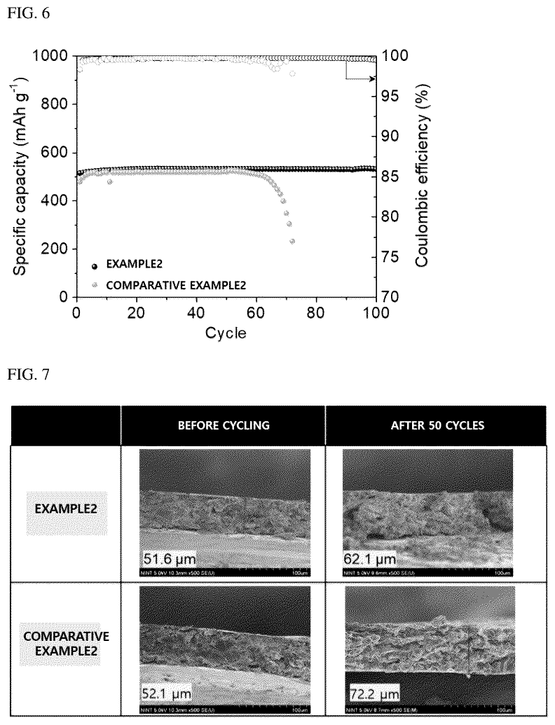

The cycle stability of electrodes including the conductive materials of Examples and Comparative Examples according to the present disclosure was evaluated. The results are presented in FIG. 6. To evaluate cycle stability, half-cells in the form of coin cells were prepared using the electrodes prepared in Example 2 and Comparative Example 2 as working electrodes, and lithium metal disks as both the counter and reference electrodes. A polypropylene separator was used, and a LiPF₆-based electrolyte in a mixed organic solvent was employed.

The cycle stability was evaluated using electrodes with a mass loading level controlled to 8 mg/cm² and 1.55 mg/cm³. An initial formation consisting of three cycles was performed within a voltage range of 0.01-1.5 V (first cycle: 0.05C discharge, 0.02C constant voltage, 0.1C charge; second and third cycles: 0.1C discharge, 0.02C constant voltage, 0.1C charge). In the subsequent cycles, charging and discharging were performed at current densities of 0.2C (discharge), 0.02C (constant voltage), and 0.5C (charge).

As shown in FIG. 6, the electrode incorporating the conductive material of Example 1 maintained its capacity retention rate without degradation even after 100 cycles. In contrast, the electrodes of Comparative Examples exhibited a rapid decline in capacity retention rate after 60 cycles. Accordingly, it was confirmed that the battery including the conductive material of the present disclosure forms strong secondary dynamic bonds with the negative electrode and the binder, which may relieve volume changes of the electrode during charging and discharging, and exhibit self-healing functionalities in the presence of defects, thereby achieving improved cycle stability.

### Experimental Example 6: Evaluation of Electrode Expansion

The degree of expansion of electrodes including the conductive materials of Examples and Comparative Examples according to the present disclosure was evaluated. The results are presented in FIG. 7. The half-cells prepared in Experimental Example 5 were disassembled after 50 charge/discharge cycles, and the degree of electrode expansion was analyzed using scanning electron microscopy (SEM).

As shown in FIG. 7, the electrode including the conductive material of Example 2 exhibited an expansion of 20% after 50 cycles, whereas the electrode including the conductive material of Comparative Example 2 exhibited an expansion of 38%. This is attributed to the fact that bare SWCNTs, which are conductive materials without any surface treatment, do not form interactions such as hydrogen bonding with silicon and the binder, and therefore may not withstand large volume changes at a silicon particle level and at an electrode level.

### Experimental Example 7: Evaluation of Cell Impedance

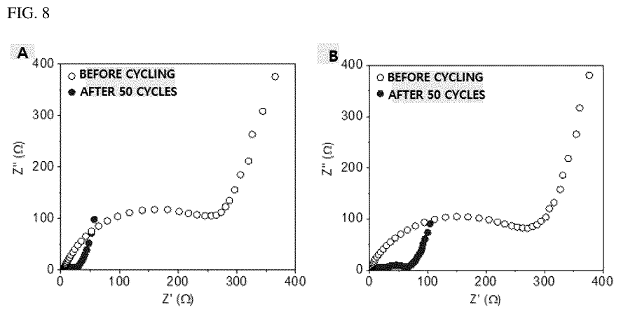

The impedance characteristics of cells including the conductive materials of Examples and Comparative Examples according to the present disclosure were evaluated. The results are presented in FIG. 8 and Table 1. Specifically, the impedance characteristics were evaluated by performing electrochemical impedance spectroscopy (EIS) on the half-cells prepared in Experimental Example 4 before cycling and after 50 cycles, under the same charge/discharge conditions and frequency range.

TABLE 1

| | R_{SEI} + R_{ct} (Ω) | |
|---|---|---|
| | Before cycling | After 50 cycles |
| Example 2 | 322.3 | 26.16 |
| Comparative | 313.2 | 60.02 |
| Example 2 | | |

As shown in Table 1 and FIG. 8, the cell of Comparative Example 2 (FIG. 8B) exhibited a larger resistance after 50 cycles than the cell of Example 2 (FIG. 8A). This is attributed to the formation of a thick and unstable SEI resistance layer resulting from the structural collapse of silicon during repeated charging and discharging (lithiation/delithiation). In contrast, it was confirmed that the conductive material, according to an example of the present disclosure, heals the collapsed silicon structure during charging and discharging, maintains electrode integrity, and results in relatively low resistance.

The features, structures, effects, and the like described in the embodiments above are included in at least an embodiment of the present disclosure and are not necessarily limited to a single embodiment. Furthermore, the features, structures, effects, and the like exemplified in each embodiment can be combined or modified in other embodiments by those having ordinary skill in the art to which the embodiments pertain. Therefore, such combinations and modifications should be construed as being within the scope of the present disclosure.

The present disclosure described as above is not limited by the aspects described herein and the accompanying drawings. It should be apparent to those having ordinary skill in the art that various substitutions, changes and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

What is claimed is:

1. A conductive material, comprising:
a carbon material; and
an amphiphilic polymer including an anionic group and a cationic group,
wherein the amphiphilic polymer is grafted onto the carbon material.

2. The conductive material according to claim 1, wherein the carbon material comprises a single-walled carbon nanotube, carbon black, carbon fiber, or any combination thereof.

3. The conductive material according to claim 2, wherein the single-walled carbon nanotube is surface-modified with a hydroxyl group or a carboxyl group.

4. The conductive material according to claim 1, wherein the amphiphilic polymer comprises a repeating unit represented by Chemical Formula 1 below: 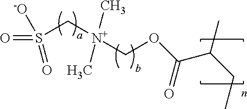
wherein a and b are each an integer in a range of 1-10, a+b≥4, and n is an integer in a range of 1-20.

5. The conductive material according to claim 1, wherein the conductive material comprises the amphiphilic polymer in a range of 1-30 parts by weight based on 100 parts by weight of the carbon material.

6. A negative electrode comprising:
the conductive material according to claim 1; and
a binder.

7. The negative electrode according to claim 6, wherein the binder is capable of interacting with the conductive material.

8. A lithium-ion battery, comprising the negative electrode according to claim 6.

9. A method for manufacturing a conductive material, the method comprising:
preparing a carbon material dispersion by dispersing a carbon material in a solvent;
grafting an amphiphilic monomer onto the carbon material by adding the amphiphilic monomer to the carbon material dispersion; and
polymerizing the amphiphilic monomer by adding an initiator to form an amphiphilic polymer.

10. The method according to claim 9, wherein the amphiphilic monomer is represented by Chemical Formula 2 below: 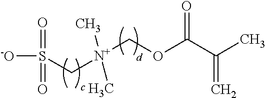
wherein c and d are each an integer in a range of 1-10, and c+d≥4.

11. The method according to claim 9, further comprising surface-modifying the carbon material before the preparing the carbon material dispersion.

12. The method according to claim 9, wherein, in the grafting, the amphiphilic monomer is added in a weight ratio in a range of 1:5-1:20 relative to the carbon material included in the carbon material dispersion.

13. The method according to claim 9, wherein, in the polymerizing, the initiator is added in an amount in a range of 0.05-0.2 wt % based on a total weight of the amphiphilic monomer added in the grafting.

14. The negative electrode according to claim 6, wherein the binder is poly(vinylidene fluoride-co-hexafluoropropylene), poly(acrylic acid), carboxymethyl cellulose, poly(vinyl alcohol), Nafion, gelatin, or any combination thereof.

15. The negative electrode according to claim 6, further comprising a negative electrode active material, wherein the negative electrode active material is natural graphite, artificial graphite, silicon/carbon, or any combination thereof.
